(19) United States
(12) Patent Application Publication
(10) Pub. No.: US 2003/0045284 A1
(43) Pub. Date: Mar. 6, 2003

(54) Wireless communication system, apparatus and method for providing communication service using an additional frequency band through an in-building communication infrastructure

(76) Inventors: Richard T. Copley, San Diego, CA (US); Fraser M. Clayton, San Diego, CA (US)

Correspondence Address: TERRANCE A. MEADOR, GRAY CARY WARE & FREIDENRICH, LLP, 4365 EXECUTIVE DRIVE, SUITE 1100, SAN DIEGO, CA, 92121-2133, US

(21) Appl. No.: 09/947,281

(22) Filed: Sep. 5, 2001

(51) Int. Cl. H04Q 7/20

(52) U.S. Cl. 455/426; 455/448; 379/56.2

(57) ABSTRACT

A system, apparatus and method provides communication services to interior mobile stations within a building structure using an in-building communication infrastructure and distribution stations positioned on selected floors of the building structure. A base station communicates through the in-building communication infrastructure using distribution frequencies suitable for transmission through the in-building communication infrastructure. The distribution stations communicate through the in-building communication infrastructure using the distribution frequencies while providing wireless service to the mobile stations within a coverage frequency bandwidth. An original cable infrastructure of a preexisting communication system can be used to distribute signals throughout the building at the distributions frequencies without the need to install new cables.

### BACKGROUND OF THE INVENTION

The invention relates in general to wireless communication and more specifically to a system, apparatus and method for providing communication service within a building using an additional frequency band through an in-building communication infrastructure.

Communication systems provide a variety of voice, multimedia, data and other services to users. Several conventional communications systems provide wireless services to users through an infrastructure using an arrangement of base stations where each base station transmits and receives signals to and from one or more mobile stations. The quality of the communication links between the mobile stations and the base stations are affected by a variety of mechanisms. For example, obstacles within the communication area may cause interference and fading. Among other undesirable situations, these mechanisms result in noisy connections, limited data throughput, dropped calls and areas having extremely limited or no communication service.

Conventional systems are particularly limited in providing communications services within building structures. The configurations of buildings coupled with construction materials such as steel and concrete prevent uniform distribution of radio signals within buildings. Communication links between mobile stations within a building and an external base station are often susceptible to high losses, interference and fading. As a result, users within a building experience the problems discussed above.

One attempt to improve in-building wireless service includes installing base stations within the building and establishing wireless service coverage to various floors through cables or wires. A base station such as Base Transceiver Station (BTS) can be installed within a building and connected to an external network through copper wire or fiber optic cable. The radio frequency (RF) output of the base station is distributed throughout the building using a radiating cable or a distributed antenna infrastructure. Signals transmitted by the mobile stations are received at the base station through the radiating cable infrastructure or antennas.

Unfortunately, installation of these systems typically accounts for 60-80 percent of the total cost. In addition to routing cables on each floor, cables must be routed between floors often requiring expensive drilling and patching of fire barriers. Installation must typically occur at night resulting in premium labor and additional security costs. Conventional systems are designed to provide coverage within a particular coverage frequency bandwidth. In order to provide service within another frequency band with conventional systems, a new infrastructure must be installed within the building or the existing infrastructure must be significantly modified or replaced.

Therefore, there is a need for an efficient method, apparatus and system for providing wireless communication service using an additional frequency band through an in-building infrastructure.

### BRIEF DESCRIPTION OF THE DRAWINGS

FIG. 1 is a block diagram of a wireless communication system in accordance with an exemplary embodiment of the invention.

FIG. 2 is a block diagram of a base interface station in accordance with the exemplary embodiment of the invention.

FIG. 3 is a block diagram of a distribution station in accordance with the exemplary embodiment of the invention.

FIG. 4 is a block diagram of an exemplary downstream frequency shifter suitable for use in the base interface station and the distribution station.

FIG. 5 is a block diagram of an exemplary upstream frequency shifter suitable for use in the base interface station and the distribution station.

FIG. 6 is a flow chart of a method of providing wireless service to interior mobile stations within a building structure in accordance with the exemplary embodiment of the invention.

FIG. 7 is a flow chart of a method of providing wireless service to mobile stations performed at the base interface station in accordance with the exemplary embodiment of the invention.

FIG. 8 is a flow chart of a method of providing wireless service to mobile stations performed at the distribution station in accordance with the exemplary embodiment of the invention.

### DETAILED DESCRIPTION OF THE PREFERRED EMBODIMENTS

In accordance with an exemplary embodiment of the present invention, an efficient method, apparatus and system provides wireless communication service to mobile stations within a building structure. An in-building communication infrastructure is used to distribute signals to and from distribution stations positioned within the building using distribution frequencies while the distribution stations wirelessly communicate with mobile stations using coverage frequencies. In the exemplary embodiment, the in-building communication infrastructure includes a preexisting distributed antenna and/or radiating cable system configured to facilitate the exchange of signals within an original coverage frequency bandwidth of an original communication system. Wireless service to mobile stations in the building is provided within an additional coverage frequency bandwidth by integrating an additional communication system with the existing in-building communication infrastructure. An additional cellular base station of the additional communication system is connected to the in-building communication infrastructure through a base interface station. The base interface station communicates with the additional cellular base station using frequencies within the additional communication frequency bandwidth while communicating through the in-building communication infrastructure using the original communication frequency bandwidth. The distribution stations communicate with the mobile stations using frequencies within the additional communication frequency bandwidth while communicating through the in-building communication infrastructure using the original communication frequency bandwidth. As discussed below, the base interface station frequency shifts signals exchanged between the in-building communication infrastructure and the additional cellular base station while the distribution stations frequency shift signals exchanged between the mobile stations and the communication infrastructure. Installation costs of the additional in-building communication system using the additional coverage frequency bandwidth are, therefore, significantly reduced by eliminating the need to install a new cable infrastructure within the building. The locations of the distribution stations can be strategically chosen to allow for uniform wireless service on a floor within the building.

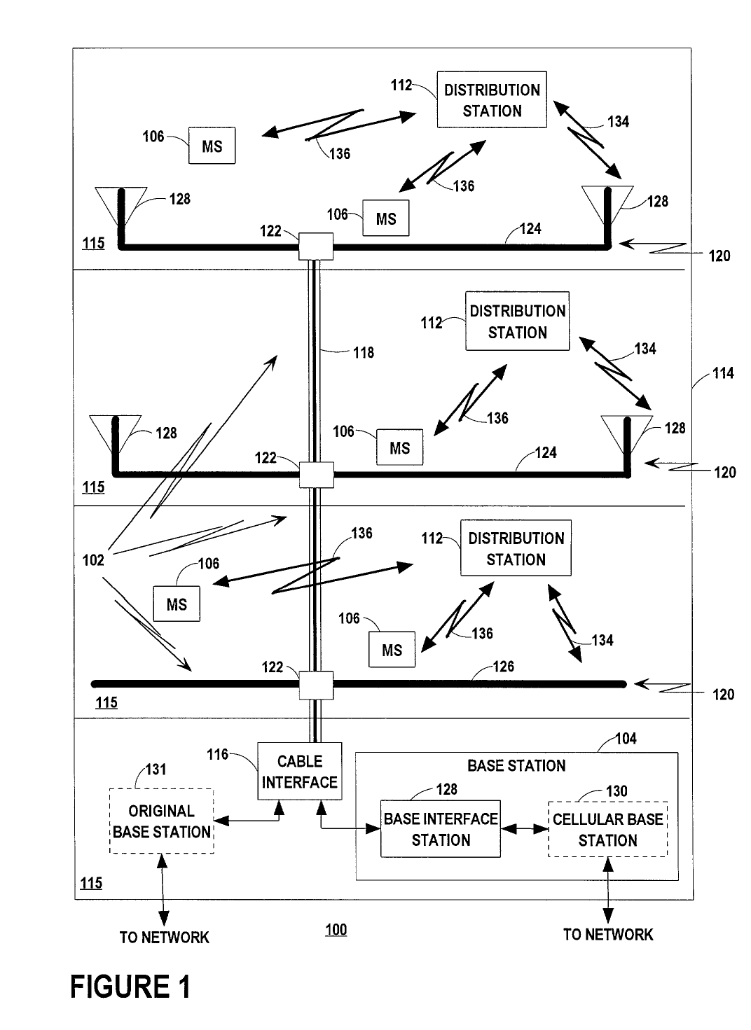

FIG. 1 is a block diagram of a wireless communication system 100 in accordance with the exemplary embodiment of the invention. The wireless communication system 100 includes at least an in-building communication infrastructure 102, a base station 104, and a distribution station 112. In the exemplary embodiment, the in-building communication system 102 includes a cable interface 116, a cable 118, a wireless interface 120, and one or more cable taps 122. The cable 118 is a physical medium for carrying communication signals and may be any suitable electrically conductive cable or wire, fiber optic cable, or waveguide. In typical implementations, the cable 118 is routed through the floors 115 of the building structure 114 near the core of the building 114. Examples of cables 118 include a coaxial cable having a center conductor and one or more shields and fiber optic cable configured to convey light signals. Where a coaxial cable (118) is used, the cable taps 122 provide a mechanism for transferring signals between the cable 118 and the wireless interface 120. An example of a cable tap 122 suitable for use with coaxial cable is an RF coupler/splitter. In systems 100 employing a fiber optic cable (118), the cable taps 122 convert signals from radio frequency (RF) signals to optical signals and vice versa to provide a communication connection between the wireless interface 120 and the cable 118. Cable taps 122 such as these are well known in the art and sometimes referred to as “RF Heads”.

The cable interface 116 provides a connection between one or more base stations and the cable 118. In systems employing a coaxial cable (118), the cable interface 116 can be an RF coupler or multiplexer. The cable interface 116, however, can include circuitry to shift signals, provide impedance matching, and otherwise translate signals for proper transmission and reception through and from the cable 118. Where the cable 118 is a fiber optic cable (118), for example, the cable interface 116 provides an RF to optical signal conversion for downstream signals and an optical signal to RF conversion for upstream signals. Optical converters are well known and the particular optical converter will depend on the characteristics of the system 100 as will be recognized by those skilled in the art.

The wireless interface 120 provides a mechanism for transmitting and receiving wireless electromagnetic signals. In the exemplary embodiment, the wireless interface includes one or more interface portions 124, 126 distributed on each selected floor 115 of the building. The interface portions 124, 126 may include distributed antenna arrangements 124 and sections of radiating cable 126. The distributed antenna arrangements 124 include one or more strategically placed antennas 128 connected by a cable to the cable tap 122. The distributed antenna arrangement 124, for example, may include two antennas positioned on opposite ends of a floor 115 of the building and connected to the cable tap 122 by a coaxial cable routed within walls, along the floor, or through the ceiling. Although the coaxial cable is typically hidden from view, the coaxial cable may be distributed in any suitable manner.

Radiating cable 126, sometimes referred to as “leaky coax”, is well known in the art and typically includes a series of holes in a shield of a coaxial cable allowing for electromagnetic signals to be transmitted and received directly through the radiating cable 126. The radiating cable 126 forms a distributed (and sometimes continuous) antenna that can be installed along or within ceilings, floors, and walls. Radiating cable 126 is often installed near base stations due to its lossy characteristics.

In the exemplary embodiment, each selected floor 115 of the building includes a cable tap 122 connected to either a radiating cable section 126 or a distributed antenna arrangement 124. The in-building communication infrastructure 102, however, may contain any combination of fiber optic cable, RF cable, distributed antenna arrangements, or sections of radiating cable. A single floor 115, for example, can include a distributed antenna arrangement 124 and one or more sections of radiating cable 126 in certain situations.

Although the present invention may be utilized in accordance with a variety of communication systems, modulation techniques, configurations, and protocols, an additional communication system is integrated with an existing in-building communication infrastructure (102) of an original communication system in the exemplary embodiment. The original communication system includes at least the in-building communication infrastructure 102, the wireless interface 120, and an original base station 131 connected within a communication network. The additional communication system includes at least a base station 104 and one or more distribution stations 112. In the exemplary embodiment, the original communication system utilizes an original communication frequency bandwidth such as the GSM 900 MHz communication frequency bandwidth and the additional communication system provides wireless service to mobile stations 106 within a building structure 114 using an additional coverage frequency bandwidth such as the GSM 1800 MHz coverage frequency bandwidth.

Those skilled in the art will readily apply the teachings herein to variety of system configurations and communication frequency bandwidths. For example, a communication system can be installed within a building 114 not containing any existing in-building communication infrastructure 102. The term “additional”, therefore, does not imply that an original communication system exists in the building 114. An in-building communication infrastructure 102 can be installed that facilitates communication within one communication frequency bandwidth, while wireless service is provided to the mobile stations 106 using another communication frequency bandwidth. Such an installation may be advantageous where no in-building infrastructure is available to efficiently carry the signals within the communication frequency bandwidth of the additional communication system. For example, physical constraints or expense may require an in-building communication infrastructure 102 that uses cables 118 that transport signals at frequencies much lower than the communication frequency bandwidth of the additional communication system.

In certain situations, the original communication system and the additional communication systems may use different protocols, modulation techniques or may differ in any way. For example, the additional communication system may be a GSM system while the original communication system may be an AMPS system. Those skilled in the art will recognize the considerations when multiple systems are integrated and simultaneously operating.

Further, the original communication system and the additional communication system may or may not be simultaneously operating. The original communication system, for example, may be replaced with the additional system by disconnecting the in-building communication infrastructure 102 from the original base station 131 and connecting the additional base station 104.

Also, the communication system 100 is not limited to only one additional communication system. Multiple additional communication systems may be connected to the in-building communication infrastructure 102 to provide wireless service within several coverage frequency bandwidths.

In the exemplary embodiment, the additional communication system is connected to the in-building communication infrastructure 102 by connecting a base interface station 128 to the cable interface 116 of the in-building communication infrastructure 102. A suitable technique of connecting the base interface station 128 to the in-building communication structure 102 includes connecting the cable interface 116 to the base interface station 128 with a coaxial radio frequency (RF) cable.

In the exemplary embodiment, the base station 104 is connected to a communication network (not shown) where the base station 104 is part of a cellular communication system such as the 1800 MHz GSM cellular system. The base interface station 128 is connected to a cellular base station 130 that is part of a conventional GSM cellular system to form a base station 104. The cellular base station 130 is shown as a block having a dashed line to illustrate that the base station 104 may be a single integrated unit. Therefore, the cellular base station 130 may be a separate device from the base interface station 128 or the base station 104 may be a single integrated unit having the functionality of the base interface station 128 and the cellular base station 130 as described herein. Those skilled in the art, however, will recognize the various suitable configurations of the base interface station 128 and the cellular base station 130 and implementations of the base stations (104, 128, 130) in accordance with the teachings herein. For example, the functionality of the base interface station 128 can be implemented in a cellular base station 130 by modifying a conventional cellular base station or manufacturing an integrated base station that functions as both a cellular base station 130 and a base interface station 128. Further, the base interface station 128 and the cellular base station 130 can be co-located or can be in different locations. In the exemplary embodiment, the base interface station 128 is connected to the cellular base station 130 through a coaxial cable. Communication and control signals, however, can be transmitted between the two units (128, 130) using a cable, radio frequency link, microwave link or any other type of wired or wireless communication channel. The cellular base station 130 communicates over a coaxial cable with the corresponding base interface station 128 using a set of communication frequencies allocated to the base station coverage region of the base station 130 for the building 114.

The following upstream and downstream examples illustrate one suitable allocation of frequencies in accordance with the exemplary embodiment where the in-building communication infrastructure 102 includes a coaxial RF cable (118). In the following examples, frequencies are indicated by Fᵤₚ(x) and F_{dn}(x) where each value of x identifies a single frequency or set of frequencies independent and distinct from frequencies identified by any other value of x. Therefore, although the following examples refer to the frequencies as single frequencies, those skilled in the art will recognize that sets of frequencies can be chosen having the same relationships as single frequencies allowing for frequency management where the various signals can be transmitted on any one of the frequencies within a frequency set. Fᵤₚ indicates an upstream frequency while F_{dn} indicates a downstream frequency. In systems using Time Division Multiple Access (TDMA) techniques such as Time Division Duplex (TDD), Fᵤₚ (x) may be the same single frequency as F_{dn} (x) for any given x. In Frequency Division Multiple Access (FDMA) and other systems, Fᵤₚ (x) does not represent a single frequency that is the same as a single frequency, F_{dn}(x), for any given x. The notation Fᵤₚ (x) for these systems identifies either a single frequency or set of frequencies that is/are different from a single frequency or set of frequencies identified by F_{dn} (x) for a particular x.

Downstream signals are processed and transmitted through the communication system 100 and received at the mobile stations 106. A signal that is to be transmitted to an interior mobile station 106 is received at the base interface station 128 from the cellular base station 130 at frequency F_{dn}(1). For this example, F_{dn}(1) is within the communication frequency bandwidth of the additional communication system and may also be used by another base station within the network for communicating with mobile stations on the outside of the building 114. In the exemplary embodiment, the downstream signal is transmitted as an RF signal having a frequency of F_{dn}(1) from the cellular base station 130 through a cable to the base interface station 128. The base interface station 128 frequency shifts the downstream signal from F_{dn}(1) to F_{dn}(2) where F_{dn}(2) is within the communication frequency bandwidth of the in-building communication infrastructure 102 and the original communication system. The base interface station 128 transmits the resulting downstream distribution signal (at F_{dn}(2)) through the in-building communication infrastructure 102. The downstream distribution signal propagates through the cable 118 and is broadcast from the wireless interface 120 through a wireless distribution channel 134.

After receiving the downstream distribution signal at F_{dn}(2), the distribution station 112 frequency shifts the downstream signal to F_{dn}(1) and transmits the resulting coverage signal at F_{dn}(1) to the mobile station 106 through a wireless coverage channel 136.

An upstream interior signal is transmitted from the mobile station 106 at a frequency Fᵤₚ(1). After receiving the interior upstream coverage signal through the wireless coverage channel 136, the distribution station 112 frequency shifts the signal from Fᵤₚ(1) to Fᵤₚ(2) to produce an upstream distribution signal. The upstream distribution signal is transmitted, at Fᵤₚ(2), to the wireless interface 120 through the wireless distribution channel 134.

After receiving the upstream distribution signal through the in-building communication infrastructure 102 at F_{dn}(2), the base interface station 128 frequency shifts the upstream distribution signal from Fᵤₚ(2) to Fᵤₚ(1) to produce an upstream coverage signal within the communication frequency bandwidth of the additional communication system. The upstream coverage signal is forwarded to the cellular base station 130.

The signals may be frequency shifted to many different communication frequency bandwidths within the in-building communication infrastructure 102. For example, signals are frequency shifted to optical frequencies for transmission through a fiber optic cable (118). Further, in may be advantageous in certain situations to use a third communication frequency bandwidth for transmitting signals through an RF coaxial cable (118). The following upstream and downstream examples illustrate one suitable allocation of frequencies in accordance with the exemplary embodiment where the in-building communication infrastructure 102 includes a fiber optic cable (118) or a third communication frequency bandwidth is utilized for transmission through the cable 118.

The base interface station 128 receives the downstream coverage signal within the communication frequency bandwidth of the additional system from the cellular base station 130 at F_{dn}(1). The base interface station 128 frequency shifts the downstream signal from F_{dn}(1) to F_{dn}(2) and forwards the downstream distribution signal to the cable interface 116. The downstream signal is converted to F_{dn}(3) where F_{dn}(3) is within a third communication frequency bandwidth. If the cable 118 is a fiber optic cable (118), the third communication frequency bandwidth is an optical communication bandwidth. The resulting downstream link signal at F_{dn}(3) is transmitted through the cable 118 to the cable taps 122. The cable taps 122 convert the downstream link signal to a downstream distribution signal at F_{dn}(2) within the communication frequency bandwidth of the original communication system. The downstream distribution signal is frequency shifted and transmitted to the mobile stations 106 as described above in the previous example.

After an upstream coverage signal is transmitted at Fᵤₚ(1), frequency shifted to Fᵤₚ(2) and received at the wireless interface 120 as described above, the cable taps 122 convert the upstream signal from the upstream distribution signal to an upstream link signal at Fᵤₚ(3) within a third communication frequency bandwidth. The third communication frequency bandwidth is the optical communication bandwidth where the cable 118 is a fiber optic cable (118).

The upstream link signal is transmitted through the cable 118 and received at the cable interface 116. The cable interface 116 converts the upstream link signal to an upstream distribution signal at Fᵤₚ(2). The base interface station 128 frequency shifts and transmits the upstream signal as discussed above in the first example.

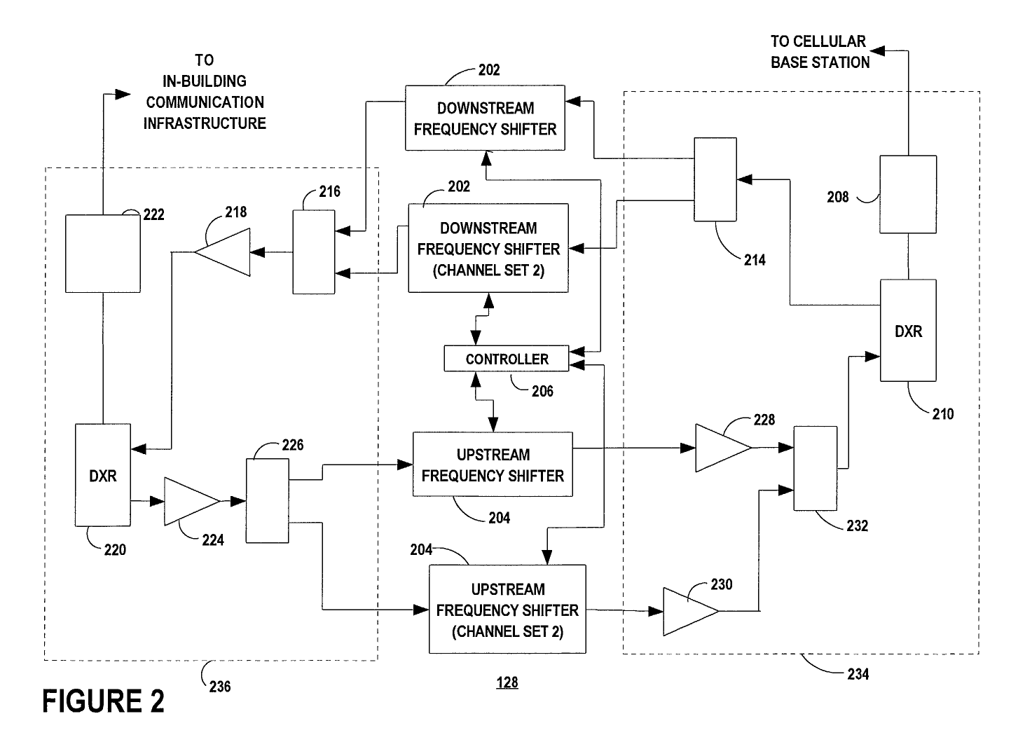

FIG. 2 is a block diagram of a base interface station 128 in accordance with the exemplary embodiment of the invention. The functional blocks in FIG. 2 may be implemented using any combination of hardware, software or firmware. The base interface station 128 in the exemplary embodiment is configured to receive two downstream signals at two different frequencies and to transmit corresponding downstream signals at two distribution frequencies. FIG. 2 illustrates blocks for receiving and processing signals at two frequencies. Similar functional blocks for processing other signals at other frequencies can be connected to the blocks shown using splitters and combiners. The teachings herein can be expanded to implement a base interface station 128 capable of processing any number of signals or channels.

The base interface station 128 includes at least a coverage communication interface 234 for communicating with the cellular base station 130 and an in-building communication interface 236 for communicating through the in-building communication infrastructure 102. The functions of the communication interfaces 234-236 can be implemented using any combination of software, hardware and firmware. Exemplary implementations are discussed below. The blocks representing the communication interfaces 234-236 are shown using dashed lines to indicate that each of the communication interfaces (234-236) may include other functional blocks or portions of function blocks shown in FIG. 2. For example, some or all of the communication interfaces 234-236 may include portions of the frequency shifters 202, 204 or the controller 206.

The base interface station 128 includes a downstream frequency shifter 202 for each channel to frequency shift an incoming downstream coverage signal to the downstream distribution frequency. An upstream frequency shifter 204 frequency shifts the upstream distribution signal to the upstream coverage frequency.

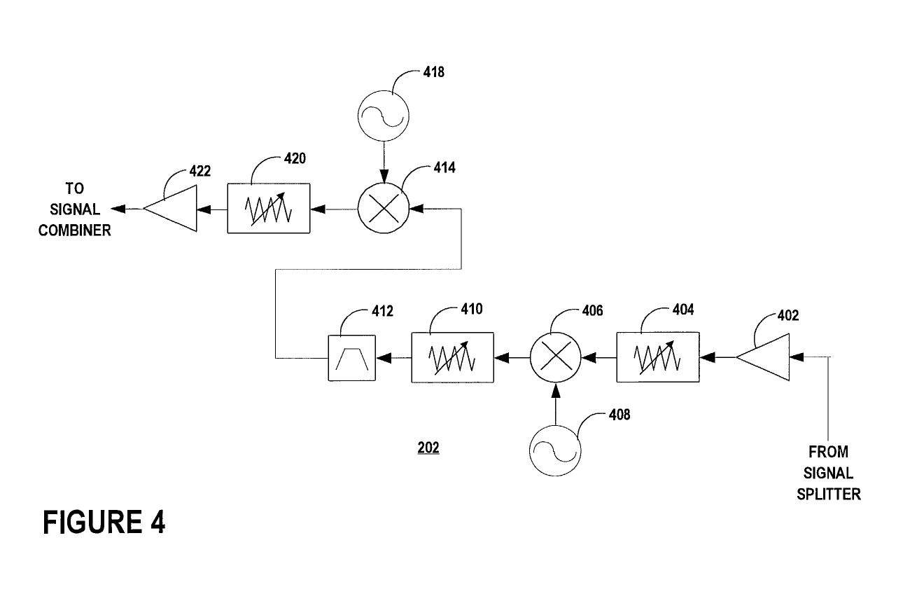

A controller 206 provides control signals to the frequency shifters 202, 204 as described below in reference to FIG. 4. In the exemplary embodiment, the controller 206 is a PC104 a microprocessor model number available from the JUMPtec® Industrielle Computertechnik AG company. The controller 206, however, may be any type of micro-processor, computer processor, processor arrangement or processor combination suitable for implementing the functionality discussed herein. Software running on the controller 206 provides the various control functions and facilitates the overall functionality of the base interface station 128.

A downstream link signal transmitted from the base station 120 at the downstream link frequency is received through an power attenuator 208. In the exemplary embodiment, the power attenuator 208 is a impedance network suitable for providing an adequate load to the cellular base station 130 while absorbing the RF power transmitted by the cellular base station 130. In situations where the cellular base station 130 is not co-located with the base interface station 128, the power attenuator 208 may be an antenna.

In accordance with known techniques, a coverage duplexer 210 allows for the use of one power attenuator 208 for receiving downstream coverage signals and transmitting upstream coverage signals from and to the cellular base station 130. The downstream coverage signal is received at the input of a signal splitter 214. In the exemplary embodiment, the signal splitter 214 has two outputs where the signals produced at each output have a power level that is approximately 3 dB lower than the power of the signal at the input. Although the signal splitter 214 may have any number of outputs, a suitable implementation includes a number of outputs in accordance with the number of downstream coverage signals that the base interface station 128 can receive. The signal produced at each output of the signal splitter 214 is received at a downstream frequency shifter 202.

Each downstream frequency shifter 202 in the base interface station 128 shifts signals at a particular frequency of the downstream coverage channel 136 to a downstream distribution frequency associated with a particular downstream coverage frequency. The various frequencies of the channels can be changed by the controller 206. In the exemplary embodiment, the frequencies are configured at the time of system installation in accordance with the system frequency allocation scheme. The base interface station 128 can be configured, depending on the particular communication system 100, to dynamically adjust frequencies during operation of the building interface station 128 within the system 100.

The downstream distribution signals at the output of each downstream frequency shifter 202 are combined in a signal combiner 216 and amplified by an amplifier 218. A distribution duplexer 220 allows for downstream distribution signals and upstream distribution signals to be transmitted and received through the same distribution attenuator 222. The distribution attenuator 222 is an impedance network providing impedance matching between the base interface station 128 and the cable interface 116. In many situations, the attenuation is relatively low and is a result of providing an appropriate matching network. In some situations, the distribution attenuator 222 may be a short length of coaxial cable.

An LNA 224 amplifies the upstream distribution signals that are received through the distribution attenuator 222 and the distribution duplexer 220. The amplified upstream distribution signal is received at an input of a signal splitter 226. In the exemplary embodiment, the signal splitter 226 has one output for each of the coverage channels and, therefore, has two outputs. The signal produced at each output of the signal splitter 226 is received at the input of each upstream frequency shifter 204.

Each upstream frequency shifter 204 shifts the upstream distribution signal from the upstream distribution frequency to the upstream coverage frequency. Each resulting upstream coverage signal is amplified in an amplifier 228, 230 and combined with the other resulting upstream signals from the other upstream frequency shifter 204 in the signal combiner 232. The combined signal, which includes upstream coverage signals at two different upstream coverage frequencies is transmitted through the coverage duplexer 210 and the coverage attenuator 208.

The various functions of the blocks in FIG. 2 may be implemented in hardware, firmware, software or any combination thereof. The functions may be combined or separated in accordance with known techniques. For example, any of the functionality described above may be implemented in a DSP, digital radio or otherwise using software, processors and other components based on these teachings and in accordance with known techniques.

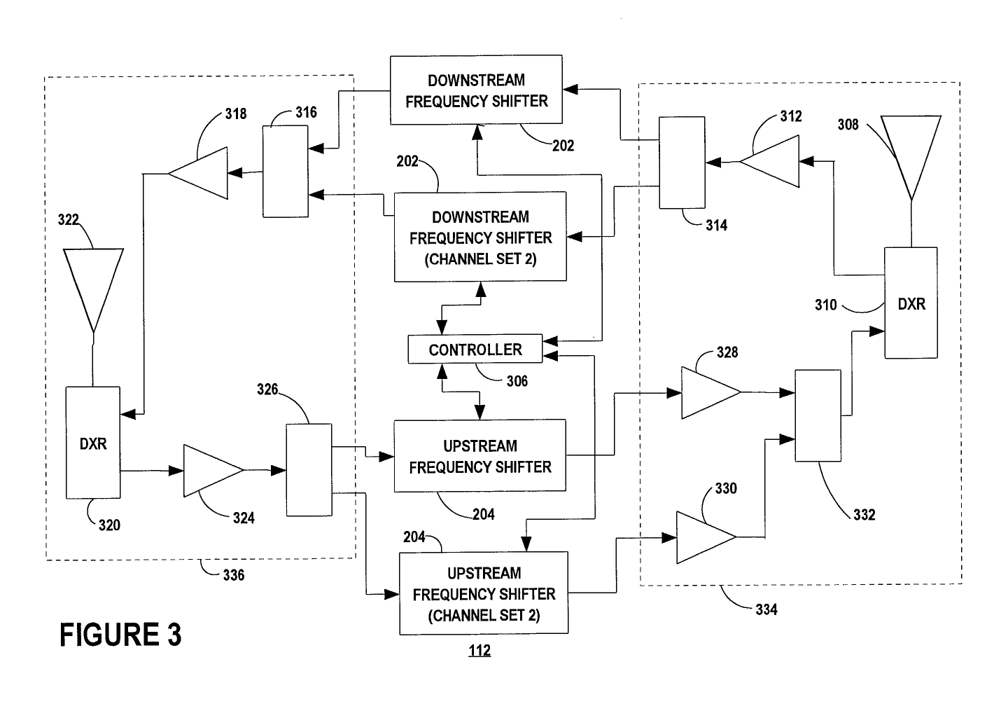

FIG. 3 is a block diagram of a distribution station 112 in accordance with the exemplary embodiment of the invention. The functional blocks in FIG. 3 may be implemented using any combination of hardware, software or firmware. The distribution station 112 in the exemplary embodiment is configured to receive two downstream distribution signals at two different frequencies and to transmit corresponding downstream coverage signals at two coverage frequencies. FIG. 3 illustrates blocks for receiving signals on two channels. The teachings herein can be expanded to implement a distribution station 112 capable of processing any number of channels. For example, in systems 100 where capacity and bandwidth are not threatened, a single downstream distribution channel and a single coverage channel can be used within a building 114.

The distribution station 112 includes at least a distribution communication interface 334 for communicating through the wireless distribution channel 134 and a coverage communication interface 336 for communicating through the wireless coverage channel 136. The functions of the communication interfaces 334, 336 can be implemented using any combination of software, hardware and firmware. Exemplary implementations are discussed below. The blocks representing the communication interfaces 334, 336 are shown using dashed lines to indicate that each of the communication interfaces (334, 336) may include other functional blocks or portions of function blocks shown in FIG. 3. For example, either or both of the communication interfaces 334, 336 may include portions of the frequency shifters 202, 204, or the controller 306.

The distribution station 112 includes a downstream frequency shifter 202 for each channel to frequency shift an incoming downstream distribution signal to the downstream coverage frequency. An upstream frequency shifter 204 for each coverage channel frequency shifts the upstream coverage signal from the upstream coverage frequency to the upstream distribution frequency to form the upstream distribution signal.

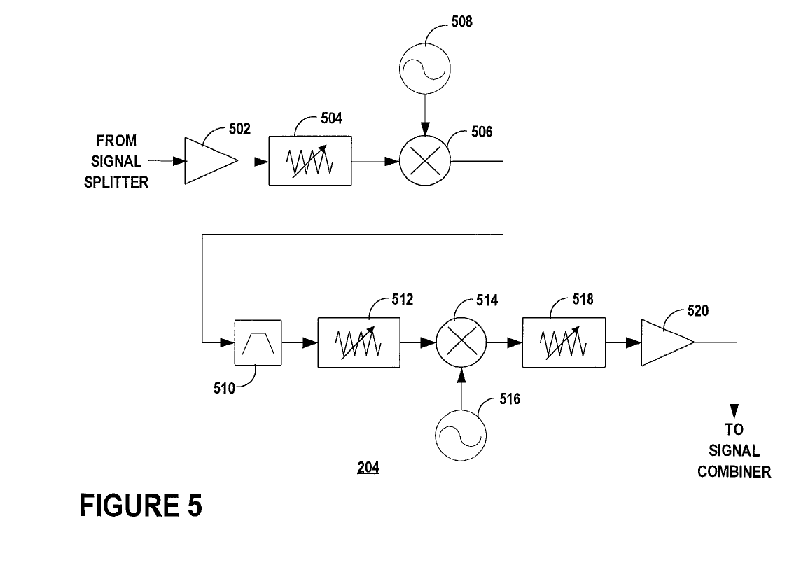

A controller 306 provides control signals to the frequency shifters 202, 204 as described below in reference to FIG. 4 and FIG. 5. In the exemplary embodiment, the controller 306 is a PC104 microprocessor available from JUMPtec® Industrielle Computertechnik AG. The controller 306, however, may be any type of micro-processor, computer processor, processor arrangement or processor combination suitable for implementing the functionality discussed herein. Software running on the controller 306 provides the various control functions and facilitates the overall functionality of the distribution station 112.

A downstream distribution signal transmitted from the building interface station 112 at the downstream distribution frequency is received through the distribution antenna 308. In the exemplary embodiment, the distribution antenna 308 is a directional antenna aligned to maximize the signal-to-noise ratio of signals transmitted between the wireless interface 120 of the in-building communication infrastructure 102 and the distribution station 112. Other types of antennas may be used and, in certain instances recognized by those skilled in the art, other types of antennas may be preferred.

In accordance with known techniques, a duplexer 310 allows for the use of a single distribution antenna 308 for receiving downstream distribution signals and transmitting upstream distribution signals. A Low Noise Amplifier (LNA) 312 amplifies the downstream distribution signal received through the distribution antenna 308 and the duplexer 310. Although several types of LNAs 312 can be used to provide the appropriate gain and noise characteristics, an example of a suitable LNA 312 is the LP1500-SOT89 PHEMT (Pseudomorphic High Electron Mobility Transistor) from Filtronic Solid-State, a division of Filtronic plc.

The amplified downstream distribution signal is received at the input of a signal splitter 314. In the exemplary embodiment, the signal splitter 314 has two outputs where the signals produced at each output have a power level that is approximately 3 dB lower than the power of the signal at the input. Although the signal splitter 314 may have any number of outputs, a suitable implementation includes a number of outputs in accordance with the number of channels that the distribution station 112 can receive. The signal at each output is received at a downstream frequency shifter 202.

As discussed in further detail below with reference to FIG. 4, the downstream frequency shifter 202 shifts the signal received at its input to a downstream coverage frequency. Each downstream frequency shifter 202 in the distribution station 112 shifts signals at the particular frequency of the wireless distribution channel 134 to a downstream coverage frequency associated with the particular distribution frequency. In the exemplary embodiment, therefore, the two downstream frequency shifters 202 shift signals at two downstream distribution frequencies with the wireless distribution channel 134 to two downstream coverage frequencies within the wireless coverage channel 136. Although the various frequencies of the channels can be changed by the controller 306, the frequencies are configured at the time of system 100 installation in accordance with the system frequency allocation scheme in the exemplary embodiment. Suitable control techniques include using a wireless modem system, or an internet protocol (IP) interface, connected to the controller 306 for channel and frequency management. The distribution station 112 can be configured, depending on the particular communication system 100, to dynamically adjust frequencies during operation of the distribution station 112 within the system 100.

The downstream coverage signals at the output of each downstream frequency shifter 202 are combined in a signal combiner 316 and amplified by an amplifier 318. A coverage duplexer 320 allows for downstream coverage signals and upstream coverage signals to be transmitted and received through the same coverage antenna 322. The coverage antenna 322 is a vertically polarized directional antenna, such as the S1857AMP10SMF antenna from Cushcraft Communications. The coverage antenna 322, however, may have any one of several configurations or polarization depending on the particular communication system 100.

An LNA 324 amplifies the upstream coverage signals that are received through the coverage antenna 322 and the coverage duplexer 320. The amplified upstream coverage signal is received at an input of a signal splitter 326. In the exemplary embodiment, the signal splitter 326 has one output for each of the coverage channels and, therefore, has two outputs. The signals produced at each output of the signal splitter 326 are received at the input of each upstream frequency shifter 204. The upstream frequency shifter 204 shifts the upstream coverage signal from the upstream coverage frequency to the upstream distribution frequency.

As discussed in further detail below with reference to FIG. 5, the upstream frequency shifter 204 shifts the signal received at its input to the upstream distribution frequency. Each upstream frequency shifter 204 in the distribution station 112 shifts signals at the particular upstream coverage frequency of the wireless coverage channel 136 to an upstream distribution frequency associated with the particular coverage frequency. In the exemplary embodiment, therefore, the two upstream frequency shifters 204 shift two signals at two upstream coverage frequencies to two upstream distribution frequencies. The upstream coverage signals at the output of each upstream frequency shifter 204 are amplified by amplifiers 328, 330 and combined in a signal combiner 332 before transmission to the wireless interface 120 through the duplexer 332 and the distribution antenna 308. In certain situations, the frequency shifters 204 can be directly connected to the signal combiner 332 and a single amplifier can be used to amplify the signal.

FIG. 4 is a block diagram of a downstream frequency shifter 202 in accordance with exemplary embodiment of the invention suitable for use within the base interface station 128 and the distribution station 112. The downstream signal is received at an input of an amplifier 402 and amplified. A variable attenuator 404 is adjusted to provide the appropriate power level of the downstream signal to a signal mixer 406. In the exemplary embodiment, analog power control signals generated by the controller 306 are received at a control inputs of the variable attenuators in the downstream frequency shifter 202. Those skilled in the art will recognize the various techniques and devices that can be used to adjust the signal power level into the downstream signal mixer 406.

The downstream signal mixer 406 mixes the downstream signal with a mixing signal generated by an oscillator 408 to shift the downstream signal to an intermediate frequency (IF). The signal mixer 406 is a down-mixer and the IF is approximately 199 MHz in the exemplary embodiment. The IF, however, can be any suitable frequency chosen in accordance with known techniques and will depend on the particular communication system 100 requirements.

The power level is adjusted by another attenuator 410 prior to filtering in a band-pass filter 412. The band-pass filter 412 is a Surface Acoustic Wave (SAW) filter having a bandwidth of approximately 0.2 MHz. Any one of several filters can be used where the selection depends on the type of system 100, bandwidth of the transmitted signal, the required Signal-to-Noise ratio (SNR) of the signals, the isolation required between coverage and distribution frequencies, and several other factors recognized by those skilled in the art. The band-pass filter 412 attenuates signals outside the desired frequency bandwidth and allows the desired signals to pass to the signal mixer 414.

In the exemplary embodiment, the oscillator 408 is controlled by the controller (206, 306) and the frequency of the mixing signal can be changed to select the desired channel to be received. A suitable configuration of the mixer 406 and oscillator 408 includes using a voltage controlled oscillator (VCO) and setting the frequency of the mixing signal through a control signal produced by the controller (206, 306).

In the distribution station 112, the filtered IF signal produced at the output of the band-pass filter 412 is mixed with a mixing signal produced by the oscillator 418 in the signal mixer 414 to shift the downstream signal to the downstream coverage frequency. The downstream signal is frequency shifted to the downstream distribution frequency in the base interface station 128 by mixing the IF signal with the appropriate mixing signal generated by the oscillator 418. The controller (206, 306) provides control signals to the oscillators 408, 418 to adjust the frequencies of the mixing signals to select the received and transmitted downstream frequencies.

The power level of the downstream signal is adjusted in the attenuator 420 and amplified in the amplifier 422. The level of the signals, however, may be adjusted using any one of several known techniques.

FIG. 5 is a block diagram of an upstream frequency shifter suitable for use in the distribution station 112 and the base interface station 128. The upstream coverage signal is received at an amplifier 502 and amplified. A variable attenuator 504 is adjusted to provide the appropriate power level of the upstream signal to an upstream distribution mixer 506. In the exemplary embodiment, analog power control signals generated by the controller (206, 306) are received at a control inputs of the variable attenuators in the upstream frequency shifter 204. Other techniques can be used to provide an upstream signal with the appropriate power level to the upstream signal mixer 506.

An oscillator 508 provides a mixing signal to the upstream signal mixer 506 to shift the signal to an IF. The frequency of the mixing signal can be changed by the controller 206, 306 by adjusting a control signal presented to a control input of the oscillator 508. The frequency of the received upstream signal, therefore, is determined by a control signal generated by the controller 206, 306.

The upstream IF signal is filtered by a band-pass filter 510 before being received at a variable attenuator 512. The band-pass filter 510 is a Surface Acoustic Wave (SAW) filter having a bandwidth of approximately 0.2 MHz. Any one of several filters can be used and depends on the particular type of communication system 100, bandwidth of the transmitted signal, the required Signal-to-Noise ratio (SNR) of the signals, the isolation required between coverage and distribution frequencies. The band-pass filter 510 attenuates signals outside the desired frequency bandwidth and allows the desired signals to pass to the variable attenuator 512 and the upstream signal mixer 514.

In the distribution station 112, an oscillator 516 provides a mixing signal to the upstream signal mixer 514 to shift the upstream IF filtered signal to the upstream distribution frequency. The IF signal is shifted to the upstream coverage frequency in the base interface station 128. The frequency of the mixing signal can be changed by the controller (206, 306) by adjusting a control signal presented to a control input of the oscillators 508, 516. The frequencies of the transmitted upstream distribution signal and the upstream coverage signal, therefore, are determined by control signals generated by the controller (206, 306). The power level of the upstream signal is adjusted by a variable attenuator 518 and amplified by an amplifier 520.

The various functions of the blocks in FIG. 4 and FIG. 5 may be implemented in hardware, firmware, software or any combination thereof. The functions may be combined or separated in accordance with known techniques. For example, any of the functionality described above may be implemented in a DSP, digital radio or otherwise using software, processors and other components based on these teachings and in accordance with known techniques. Further, the upstream frequency shifter and the downstream frequency shifter may implemented as single integrated circuit such as an Application Specific Integrated Circuit (ASIC), using discrete components or any combination thereof

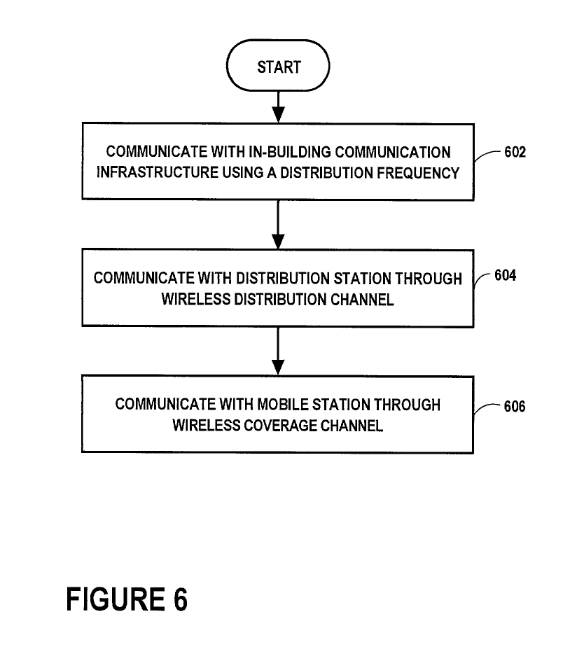

FIG. 6 is a flow chart of a method of providing wireless service to a mobile station 106 within the building structure 114. In the exemplary embodiment, the steps are performed within the wireless communication system 100, where any step may be performed either partially or wholly within any one of the elements of the system 100.

At step 602, the base station 104 communicates with the in-building communication infrastructure using the distribution frequency. In the exemplary embodiment, the base interface station 128 communicates with the cellular base station 130 using a coverage frequency within the coverage frequency bandwidth of the additional communication system while communicating with the cable interface 116 using a distribution frequency within the coverage frequency bandwidth of the original communication system. The cable interface 116 transmits and receives signals through the cable 118 corresponding to the distribution signals received and transmitted between the base interface station 128 and the cable interface 116. In systems where the cable 118 is a fiber optic cable (118), the cable interface 116 provides the appropriate signal conversions from RF to light and from light to RF. Where the cable 118 is a coaxial cable (118) or other medium (118) suitable for conveying RF signals, the distribution signals may be transmitted at the distribution frequency through the cable 118. In some circumstances, the distribution signals may transmitted through the cable 118 using RF frequencies other than the distribution frequencies. As explained above, the cable taps 122 perform any required conversion to allow communication through the wireless interface 120 at the distribution frequency.

At step 604, communication is established between with the distribution station 112 through the wireless distribution channel 128. In the exemplary embodiment, the wireless interface 120 of the in-building communication infrastructure 102 exchanges distribution signals with the distribution station 112 using one or more distribution frequencies. As explained above, the distribution signals exchanged between the distribution station 112 and the wireless interface 120 correspond to the signals exchanged between the base station 104 and the cable interface 116 of the in-building communication infrastructure 102.

At step 606, communication is established with the mobile station 106 through the wireless coverage channel 136. Coverage signals corresponding to the distribution signals are exchanged between the distribution station 112 and the mobile station 106 using coverage frequencies with the coverage frequency bandwidth of the additional communication system.

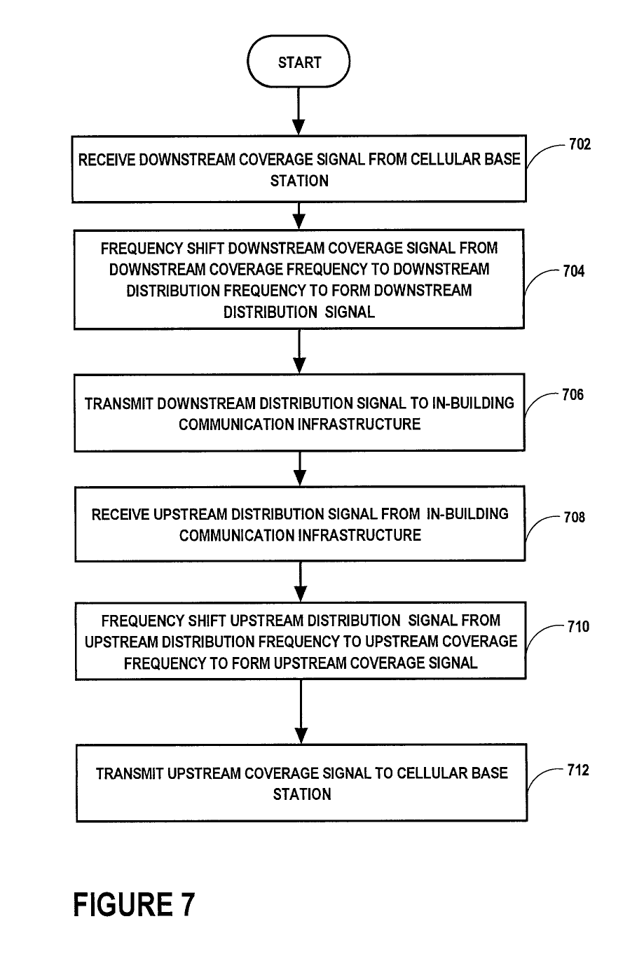

FIG. 7 is a flow chart of a method of providing wireless service to mobile stations 106 performed at the base interface station 128 in accordance with the exemplary embodiment of the invention. The method can be performed within the base station 120. In the exemplary embodiment, the method performed in the base interface station 128 is implemented using hardware and software code running on the controller 206. Those skilled in the art will readily apply known techniques to the teachings herein to implement the method in the base interface station 128 and/or base station 104 using other techniques. Steps 702, 704, 710, and 712 provide and exemplary method of performing step 602 of FIG. 6.

At step 702, the base interface station 128 receives a downstream coverage signal from a cellular base station 130 such as a BTS. As explained above, the signals between the base interface station 128 and the cellular base station 130 are exchanged over a coaxial cable connecting the two devices.

At step 704, the base interface station 128 frequency shifts the downstream coverage signal from the downstream coverage frequency to the downstream distribution frequency to form the downstream distribution signal. In the exemplary embodiment, the signal mixer 406 and oscillator 408 are used to shift the downstream coverage signal to an IF. The IF signal is filtered and shifted to the downstream distribution frequency using the mixer 414 and oscillator 418. The signals, however, can be processed and shifted using digital techniques.

At step 706, the base interface station 128 transmits the downstream distribution signal to the in-building communication infrastructure 102. In the exemplary embodiment, the downstream distribution signal is transmitted to the cable interface 116, where it is processed for transmission through the cable 118 to the cable taps 122.

At step 708, the base interface station 128 receives the upstream distribution signal from the in-building communication infrastructure 102. In the exemplary embodiment, the cable interface 116 performs any required conversion and transmits the upstream distribution signal within the coverage frequency bandwidth of the original communication system to the base interface station 128 through a cable.

At step 710, the base interface station 128 frequency shifts the upstream distribution signal from the upstream distribution frequency to the upstream coverage frequency to form the upstream coverage signal. A suitable method of shifting the signal includes mixing the signal to an IF prior to mixing the resulting IF with an appropriate mixing signal using the signal mixers 506, 514 and oscillators 508, 516.

At step 712, the base interface station 128 transmits the upstream coverage signal to the cellular base station 130. The base interface station 128 includes the appropriate hardware and software for transmitting the upstream coverage signal through a coaxial cable to the cellular base station 130 as explained above.

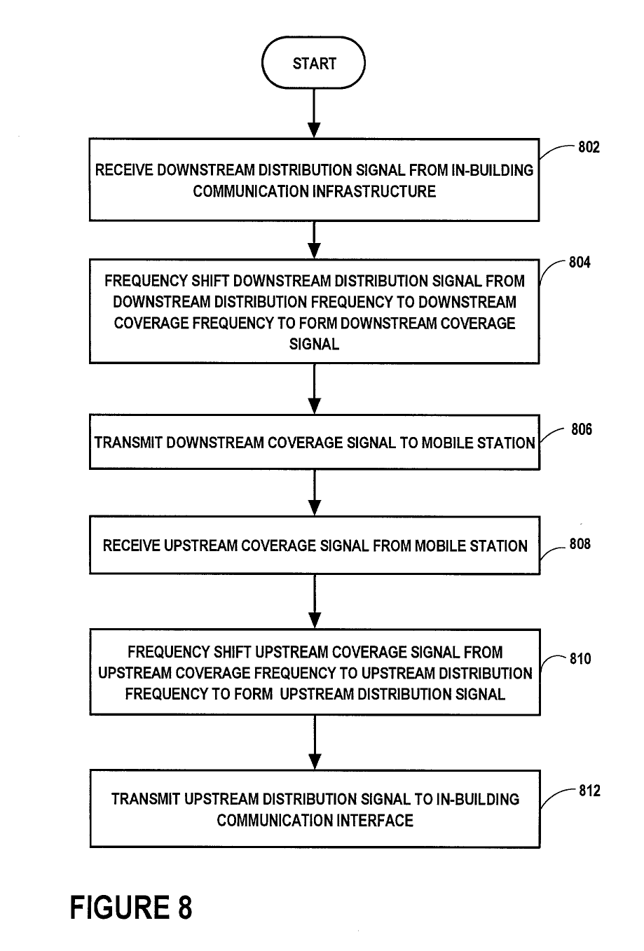

FIG. 8 is a flow chart of a method of providing wireless service to mobile stations 106 performed at the distribution station 112 in accordance with the exemplary embodiment of the invention. In the exemplary embodiment, the method performed in the distribution station 112 is implemented using hardware and software code running on the controller 306. Those skilled in the art will readily apply known techniques to the teachings herein to implement the method in the distribution station 112 using other techniques. Steps 802, 804, 810, and 812 in combination with steps 704, 706, 708, and 710 provide and exemplary method of performing step 604 of FIG. 6. Steps 804, 806, 808, and 810 provide an exemplary method of performing step 606 of FIG. 6.

At step 802, the distribution station 112 receives the downstream distribution signal from the in-building communication infrastructure 102. In the exemplary embodiment, the downstream distribution signal is transmitted by the wireless interface 120 and received through the distribution communication interface 334 which includes various receiver components as discussed above.

At step 804, the distribution station 112 frequency shifts the downstream distribution signal from the downstream distribution frequency to the downstream coverage frequency to form the downstream coverage signal. A suitable method of shifting the signals includes using the downstream frequency shifter 202. The downstream coverage signal has a frequency within the coverage frequency bandwidth of the additional communication system.

At step 806, the distribution station 112 transmits the downstream coverage signal to the mobile station 106. The coverage communication interface 336 provides suitable transmitter implementation for transmitting the downstream signals to the mobile stations 106.

At step 808, the distribution station 112 receives the upstream coverage signal from the mobile station 106. As discussed above, the coverage communication interface 336 provides a suitable receiver configuration for receiving the upstream signals from the mobile stations 106. The upstream coverage signal has frequency within the coverage frequency bandwidth of the additional communication system.

At step 810, the distribution station 112 frequency shifts the upstream coverage signal from the upstream coverage frequency to the upstream distribution frequency to form the upstream distribution signal. The upstream frequency shifter 204 is used to mix the upstream signals to an IF and from the IF to the upstream distribution frequency in the exemplary embodiment.

At step 812, the distribution station 112 transmits the upstream distribution signal to the in-building communication infrastructure 102. The upstream distribution signals are transmitted through the distribution communication interface 334 in the exemplary embodiment and received by the wireless interface 120.

Therefore, in the exemplary embodiment of the invention, wireless service to mobile stations 106 is provided through a communication system 100 utilizing an in-building communication infrastructure 102 and one or more distribution stations 112. Coverage frequencies are used to communicate between a cellular base station 130 and a base interface station 128 and between the distribution station 112 and mobile stations 106. Distribution signals corresponding to coverage signals are used to interface with a cable interface 116 and a wireless interface 120 of an in-building communication infrastructure 102. The distribution signals have distribution frequencies within a coverage frequency bandwidth of the in-building communication infrastructure 102. The method, apparatus and system of the invention provides wireless service to mobile stations 106 within a coverage frequency bandwidth not directly supported by the in-building communication infrastructure 102.

Clearly, other embodiments and modifications of this invention will occur readily to those of ordinary skill in the art in view of these teachings. Therefore, this invention is to be limited only by following claims, which include all such embodiments and modifications when viewed in conjunction with the above specification and accompanying drawings.

We claim:

1. A method comprising:
communicating through an in-building communication infrastructure using a distribution frequency within a first coverage frequency bandwidth; and
communicating with a mobile station using a coverage frequency within a second coverage frequency bandwidth.

2. A method in accordance with claim 1, wherein communicating through the in-building communication infrastructure comprises:
communicating through a wireless distribution channel to a wireless interface of the in-building communication infrastructure using the distribution frequency.

3. A method in accordance with claim 2, wherein the wireless interface comprises a radiating cable.

4. A method in accordance with claim 2, wherein the wireless interface comprises a distributed antenna infrastructure.

5. A method in accordance with claim 2, wherein communicating through the in-building communication infrastructure further comprises:
communicating through a radio frequency cable of the in-building communication infrastructure using the distribution frequency.

6. A method in accordance with claim 2, wherein communicating through the in-building communication infrastructure further comprises:
communicating through a fiber optic cable of the in-building communication infrastructure using an optic frequency.

7. A method in accordance with claim 2, wherein:
communicating through the in-building communication infrastructure further comprises receiving a downstream distribution signal within the first coverage frequency bandwidth through a wireless distribution channel from a wireless interface of the in-building communication infrastructure; and
communicating with the mobile station comprises transmitting a downstream coverage signal within the second coverage frequency bandwidth through a wireless coverage channel to the mobile station.

8. A method in accordance with claim 7, further comprising:
frequency shifting the downstream distribution signal from a downstream distribution frequency within the first coverage frequency bandwidth to a downstream coverage frequency within the second coverage frequency bandwidth to form the downstream coverage signal.

9. A method in accordance with claim 2, wherein:
communicating with the mobile station comprises receiving an upstream coverage signal within the second coverage frequency bandwidth through a wireless coverage channel from the mobile station; and
communicating through the in-building communication infrastructure further comprises transmitting an upstream distribution signal within the first coverage frequency bandwidth through a wireless distribution channel to a wireless interface of the in-building communication infrastructure.

10. A method in accordance with claim 9, further comprising:
frequency shifting the upstream coverage signal from an upstream coverage frequency within the second coverage frequency bandwidth to an upstream distribution frequency within the first coverage frequency bandwidth to form the upstream distribution signal.

11. A method comprising:
receiving a downstream distribution signal from a wireless interface of an in-building communication infrastructure corresponding to a downstream coverage signal transmitted from a cellular base station, the downstream coverage signal having a downstream coverage frequency within a coverage frequency bandwidth of the cellular base station;
frequency shifting the downstream distribution signal from a downstream distribution frequency to the downstream coverage frequency to form the downstream coverage signal;
transmitting the downstream coverage signal to a mobile station within a building structure containing the in-building communication infrastructure;
receiving an upstream coverage signal from the mobile station;
frequency shifting the upstream coverage signal from an upstream coverage frequency within the coverage frequency bandwidth to an upstream distribution frequency to form an upstream distribution signal; and
transmitting the upstream distribution signal to the wireless interface.

12. A method in accordance with claim 11, wherein the distribution frequency is within another coverage frequency bandwidth.

13. A method in accordance with claim 12, wherein the in-building communication infrastructure is part of an original cellular communication system for providing wireless service to mobile stations using the another coverage frequency bandwidth.

14. A method comprising:
communicating with a distribution station through an in-building communication infrastructure using a distribution frequency within a first coverage frequency bandwidth; and
communicating with a cellular base station using a coverage frequency within a second coverage frequency bandwidth, wherein the distribution station is configured to communicate with a mobile station using the coverage frequency.

15. A method in accordance with claim 14, wherein the communicating with the distribution station comprises:
communicating with a cable interface of the in-building communication infrastructure using distribution signals within the first coverage frequency bandwidth, wherein a wireless interface of the in-building communication infrastructure is configured to communicate with the distribution station through a wireless distribution channel using the distribution signals.

16. A method in accordance with claim 15, wherein the communicating with the cable interface comprises:
transmitting a downstream distribution signal to the cable interface through a coaxial cable, the downstream distribution signal transmitted from the wireless interface to the distribution station through the wireless distribution channel and corresponding to a downstream coverage signal received from the cellular base station; and
receiving an upstream distribution signal from the cable interface through the coaxial cable, the upstream distribution signal received at the wireless interface through the wireless distribution channel from the distribution station.

17. A method comprising:
communicating between a base interface station and a cellular base station using a first coverage frequency bandwidth;
communicating between the base interface station and an in-building communication infrastructure using a second coverage frequency bandwidth;
communicating between a distribution station and the in-building communication infrastructure using the second coverage frequency bandwidth; and
communicating, using the first coverage frequency bandwidth, between a distribution station and a mobile station located with a building structure containing the in-building communication infrastructure.

18. A method in accordance with claim 17 wherein the communicating between the distribution station and the in-building communication infrastructure comprises:
receiving a downstream distribution signal from a wireless interface of the in-building communication interface through a wireless distribution channel; and
transmitting an upstream distribution signal to the wireless interface through the wireless distribution channel.

19. A method in accordance with claim 18 wherein the communicating between the distribution station and the mobile station comprises:
transmitting a downstream coverage signal to the mobile station through a wireless channel; and
receiving an upstream coverage signal from the mobile station through the wireless coverage channel.

20. A method in accordance with claim 19, further comprising:
frequency shifting the downstream distribution signal from a downstream distribution frequency within the second coverage frequency bandwidth to a downstream coverage frequency within the first coverage frequency bandwidth to form the downstream coverage signal; and
frequency shifting the upstream coverage signal from an upstream coverage frequency within the first coverage frequency bandwidth to an upstream distribution frequency within the second coverage frequency bandwidth to form the upstream distribution signal.

21. A method in accordance with claim 17 wherein the communicating between the base interface station and the in-building communication infrastructure comprises:
receiving the upstream distribution signal from a cable interface of the in-building communication interface through a coaxial cable;
and transmitting the downstream distribution signal to the cable interface through the coaxial cable.

22. A method in accordance with claim 21 wherein the communicating between the base interface station and the cellular base station comprises:
transmitting the upstream coverage signal to the cellular base station; and
receiving the downstream coverage signal from the cellular base station.

23. A method in accordance with claim 22, further comprising:
frequency shifting, at the base interface station, the upstream distribution signal from the upstream distribution frequency to the upstream coverage frequency to form the upstream coverage signal; and
frequency shifting, at the base interface station, the downstream coverage signal from the downstream coverage frequency to the downstream distribution frequency to form the downstream distribution signal.

24. A distribution station.

25. A distribution station comprising:
a coverage communication interface configured to communicate with a mobile station located within a building structure through a wireless coverage channel using a coverage frequency within a first coverage communication frequency bandwidth; and
a distribution communication interface configured to communicate with an in-building communication infrastructure through a wireless distribution channel using a distribution frequency within a second coverage frequency bandwidth.

26. A distribution station in accordance with claim 25, further comprising:
an upstream frequency shifter connected between the coverage communication interface and the distribution communication interface, the upstream frequency shifter configured to frequency shift an upstream coverage signal received through the coverage interface to an upstream distribution frequency to form an upstream distribution signal; and
a downstream frequency shifter connected between the distribution communication interface and the coverage communication interface, the downstream frequency shifter configured to frequency shift a downstream distribution signal received through the distribution communication interface from a downstream distribution frequency to a downstream coverage frequency.

27. A distribution station in accordance with claim 26, wherein the coverage communication interface comprises:
a coverage antenna configured to receive the upstream coverage signal and to transmit the downstream coverage signal.

28. A distribution station in accordance with claim 27, wherein the distribution communication interface comprises:
a distribution antenna configured to receive the downstream distribution signal and to transmit the upstream distribution signal.

29. A base interface station.

30. A base interface station comprising:
a coverage communication interface configured to communicate with a cellular base station using a coverage frequency within a first coverage communication frequency bandwidth; and
a distribution communication interface configured to communicate with an in-building communication infrastructure using a distribution frequency within a second coverage frequency bandwidth.

31. A base interface station in accordance with claim 30, further comprising:
a downstream frequency shifter connected between the coverage communication interface and the distribution communication interface, the downstream frequency shifter configured to frequency shift a downstream coverage signal received through the coverage interface to a downstream distribution frequency to form a downstream distribution signal within the second coverage communication bandwidth; and
an upstream frequency shifter connected between the distribution communication interface and the coverage communication interface, the upstream frequency shifter configured to frequency shift an upstream distribution signal received through the distribution communication interface from an upstream distribution frequency to an upstream coverage frequency.

32. A system comprising:
a base interface station comprising:
a first coverage communication interface configured to communicate with a cellular base station using a coverage frequency within a first coverage communication frequency bandwidth; and
a first distribution communication interface configured to communicate with an in-building communication infrastructure using a distribution frequency within a second coverage frequency bandwidth; and
a distribution station comprising:
a second coverage communication interface configured to communicate with a mobile station located within a building structure through a wireless coverage channel using the coverage frequency within the first coverage communication frequency bandwidth; and
a second distribution communication interface configured to communicate with the in-building communication infrastructure through a wireless distribution channel using the distribution frequency within the second coverage frequency bandwidth.

33. A system in accordance with claim 32, further comprising the in-building communication infrastructure, the in-building communication infrastructure comprising:
a wireless interface configured to communicate with the distribution station through the wireless distribution channel within the second coverage frequency bandwidth; and
a cable interface configured to communicate with the cellular base station using the first coverage communication bandwidth.

34. A system in accordance with claim 33, wherein the distribution station further comprises:
a first upstream frequency shifter connected between the first coverage communication interface and the first distribution communication interface, the first upstream frequency shifter configured to frequency shift an upstream coverage signal received through the first coverage interface to an upstream distribution frequency to form an upstream distribution signal; and
a first downstream frequency shifter connected between the first distribution communication interface and the first coverage communication interface, the first downstream frequency shifter configured to frequency shift a downstream distribution signal received through the first distribution communication interface from a downstream distribution frequency to a downstream coverage frequency.

35. A system in accordance with claim 34, wherein the first coverage communication interface further comprises:
a coverage antenna configured to receive the upstream coverage signal and to transmit the downstream coverage signal.

36. A system in accordance with claim 35, wherein the first distribution communication interface comprises:
a distribution antenna configured to receive the downstream distribution signal and to transmit the upstream distribution signal.

37. A system in accordance with claim 36, wherein the base interface station further comprises:
a second downstream frequency shifter connected between the coverage communication interface and the distribution communication interface, the second downstream frequency shifter configured to frequency shift a downstream coverage signal received through the coverage interface to a downstream distribution frequency to form a downstream distribution signal within the second coverage communication bandwidth; and
a second upstream frequency shifter connected between the distribution communication interface and the coverage communication interface, the second upstream frequency shifter configured to frequency shift an upstream distribution signal received through the distribution communication interface from an upstream distribution frequency to an upstream coverage frequency.
